(19) United States
(12) Patent Application Publication
(10) Pub. No.: US 2018/0046945 A1
(43) Pub. Date: Feb. 15, 2018

(54) METHOD AND SYSTEM FOR OBTAINING SERVICES

(71) Applicants: AKIVA ELIASH, TEL AVIV (IL); ITAY BUBLIL, TEL AVIV (IL)

(72) Inventors: AKIVA ELIASH, TEL AVIV (IL); ITAY BUBLIL, TEL AVIV (IL)

(21) Appl. No.: 15/675,806

(22) Filed: Aug. 14, 2017

Related U.S. Application Data
(60) Provisional application No. 62/374,845, filed on Aug. 14, 2016.

(51) Int. Cl. G06Q 10/02; G06Q 50/10; G06Q 50/00; G06Q 30/08; G06Q 30/02

(52) U.S. Cl. CPC G06Q 10/02; G06Q 30/08; G06Q 30/0282; G06Q 50/01; G06Q 50/10

(57) ABSTRACT

A method and system for obtaining tradesman services, the method including creating a database of tradesmen according to skill category; receiving a request to perform a service or work by a tradesman in a selected skill category at a selected time and at a geographical location; broadcasting the request among at least a portion of the tradesmen in the selected category in the database; conducting an auction to perform the requested service or work among the tradesmen to whom the request was broadcast, including receiving at least one bid from at least one of the tradesman; displaying the bid on communication devices of a customer requesting the service or work and other tradesman in the auction; receiving a customer selection of one of the displayed bids; and notifying the tradesman who made the selected bid.

### RELATED APPLICATIONS

The present application claims the benefit of U.S. Provisional Patent Application No. 62/374,845 filed on Aug. 14, 2016. The disclosure of this prior application is considered part of and is incorporated by reference in the disclosure of this application.

### FIELD OF THE INVENTION

The present invention relates to a method and system for obtaining tradesman services, in general and, in particular, to a system and method for matching a tradesman with a customer in need of his or her services.

### BACKGROUND OF THE INVENTION

Finding an available and trustworthy tradesman or service provider is not simple. At present, one must rely on advertisements, such as Yellow Pages, or word of mouth, in order to find a tradesman. And then, one does not always know whether the person is a qualified professional, reliable, honest and worth hiring. Furthermore, often a customer does not know what is a fair or proper price to pay for the service or work to be done, as each professional provides a cost estimate as he or she sees fit. In order to obtain a number of cost estimates, it is necessary to phone or contact by email or in another fashion a number of tradesmen with regard to the same job and sort through the various responses. Similarly, the availability of the tradesmen at the time they are needed, particularly under circumstances of urgency is problematic. Customers are often promised that a tradesman will arrive within a window of several hours, but the tradesmen do not always comply.

With the rise of Internet advertising and the possibility of finding people with many skills using Google® searches, it has become popular to rate or grade tradesmen and their services so that later consumers can rely on other people's experiences.

Accordingly, there is a long felt need for a method and system to help locate a reliable tradesman at a reasonable price and within a reasonable time period, and it would be very desirable if such a system provided means to observe the location of the tradesman relative to the place where the service is to be performed.

### SUMMARY OF THE INVENTION

The present invention relates to a system and method for obtaining services of a tradesman utilizing a smart cellular telephone or any other processing device having internet communication means, in real time. The method includes conducting an auction to provide services requested by a customer, so as to permit a customer to select a tradesman who can best provide the needed services, taking into account location, time, cost and skill of the tradesman. The customer also has access to reviews of previous customers to help her or him make a sound decision. The system includes a server holding a database of details of a plurality of tradesmen categorized according to the services they provide, a database of details of a plurality of customers who have registered to use the system as well as details of already provided services. Preferably, a standard price list is provided for various services, and registered tradesmen in a pre-defined geographical area are notified of the service request. Each interested tradesman submits a bid (offered price) for the requested service, taking into account the location of the customer and the requested time for performance of the service, via the server, which bid is displayed to the other tradesmen and to the customer. This permits additional bids by the various tradesmen, to reach the lowest bid price for performance of the service. At the end of the auction, the customer selects the tradesman to perform the job, typically, although not necessarily, the tradesman who submitted the lowest bid. After performance of the service or job, the customer pays the tradesman, and the customer and the tradesman rate each other. These ratings are associated with the respective customer or tradesman profiles in the server, which are available for perusal by other customers and tradesmen when preparing later requests for service or reviewing bids. The tradesman's and customer's communication devices preferably include GPS driven maps, or another geographical location mechanism, processing the coordinate data to identify the location of the service or work to be performed and to permit the customer to identify where the tradesman is, and possibly vice versa, and to confirm that tradesman will reach the location of the service or work to be performed at the fixed time.

There is thus provided, according to the present invention, a method for obtaining tradesman services, the method including creating a database of tradesmen according to skill category; receiving a request to perform service or work by a tradesman in a selected skill category at a selected time and at a geographical location; broadcasting the request among at least a portion of the tradesmen in the selected category in the database; conducting an auction to perform the requested service or work among the tradesmen to whom the request was broadcast, including receiving at least one bid from at least one of the tradesman; displaying the bid on communication devices of a customer requesting the service or work and other tradesman in the auction; receiving a customer selection of one of the displayed bids; and notifying the tradesman who made the selected bid.

According to preferred embodiments of the invention, the step of selecting includes selecting the tradesman who provided the lowest bid.

According to exemplary embodiments of the invention, the method further includes receiving an indication that the tradesman has performed the requested service or work; and storing a customer rating of the tradesman and of the requested service or work for later viewing.

If desired, the step of broadcasting can include broadcasting a photograph, uploaded by the customer, of the requested service or work.

Preferably, the step of broadcasting includes broadcasting within a pre-defined geographic area relative to geographical location of service or work.

There is further provided, according to the invention, a system for obtaining tradesman services, the system including a server holding a database of tradesmen arranged according to skill category; a processor in the server coupled for two-way communication via the to a plurality of tradesman communication devices, each tradesman communication device, a display, a geographical location identifier, and to a plurality of customer communication devices, each customer communication device having a display, a geographical location identifier and being coupled to a camera; the processor coupled to the customer communication devices for receiving from one of the customer communication devices a request to perform service or work by a tradesman in a selected skill category at a selected time and at a geographical location; the processor coupled to the tradesman communication devices for broadcasting the request among the tradesman communication devices of at least a portion of the tradesmen in the selected skill category in the database; and the processor adapted and configured to conduct an auction among the tradesmen to whom the request was broadcast to perform the requested service work, including receiving a signal from at least one of the tradesman communication devices indicating a price bid and causing a graphical representation of the bid to be displayed on a display of the customer communication device and the tradesman communication devices that received the broadcast; and a graphic confirmation of performance of the requested service or work and payment therefor.

### BRIEF DESCRIPTION OF THE DRAWINGS

The present invention will be further understood and appreciated from the following detailed description taken in conjunction with the drawings in which:

FIG. 1 is a flow chart illustrating the method of obtaining services according to some embodiments of the present invention; and

FIG. 2 is a flow chart illustrating the process of uploading project order according to the invention.

FIG. 3 is a flow chart illustrating the process of bidding according to the invention.

FIG. 4 is a schematic illustration of a system according to some embodiments of the present invention, suitable for implementing the method according to some embodiments of the present invention.

### DETAILED DESCRIPTION OF THE INVENTION

The present invention relates to a method and system for obtaining tradesman services at reasonable prices in real time, using smart communication devices having cellular and/or landline means of communication. Any computing device capable of digital processing of data and providing two-way communication can be utilized. According to the invention, obtaining tradesman services at reasonable prices in real time is accomplished by conducting an auction to provide the services requested by a customer at the lowest cost, so as to permit a customer to select a tradesman who can best provide the needed services, taking into account location, time, cost and skill of the tradesman. For purposes of the present invention, a tradesman includes any person or business offering and performing physical work or repair or service. It will be appreciated that the method can be implemented as a software application (app) on the communication device or can be implemented as a web app on a system web site accessible by computing and processing devices via a web browser. The method of the present invention will now be described with reference to

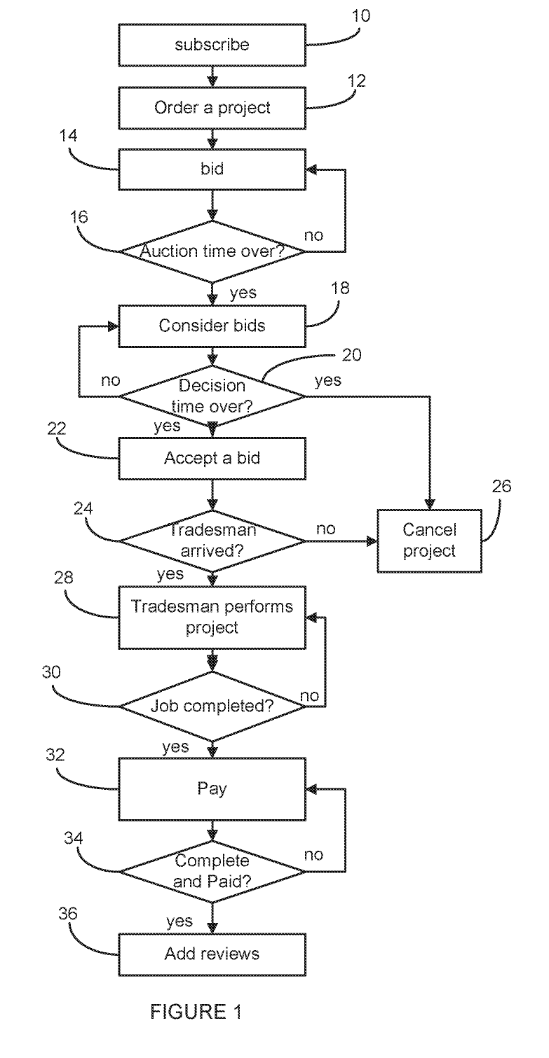

FIG. 1, a flow chart illustrating the method of obtaining services according to some embodiments of the present invention.

Both customers and tradesmen must subscribe to the system (block 10) in order to use the service. Upon subscribing, a customer downloads a customer software application (app) onto his or her communication device, such as a smart cellular telephone or tablet or a PC. Subscribing or registration can be accomplished in any conventional manner. In particular, the customer typically is prompted by the app to key in personal details, such as name, address, phone number, preferably with a photo of the customer. These details can be saved for future auto-fill by the customer's communication device and are stored in the system server. If desired, the customer can choose to register using Facebook®, Google®, or using their email address, or in any other fashion. If they choose to register using Facebook® or Google®, the system will fetch their address, profile picture, phone number and email, if available. The data that is not available will be filled in by the customer, manually. The customer preferably will select a password for use in the system and will review the terms of service, as known.

Similarly, each tradesman offering services will download a service provider version of the app. The tradesman typically is prompted by the app to key in such details as name, business address or service or work area, phone number, preferably with a photo of the tradesman and/or logo. In addition, the tradesman adds the category of his or her profession or service (which can also be via a dropdown box), an address for a website and a possible brief description of his or her business. Each tradesman can choose up to a pre-selected number of skills to enter into the database. The tradesman will receive offers from customers who are opening auctions requiring each of the skill sets the tradesman has indicated. If desired, the tradesman also can choose to register using Facebook , Google®, or using his or her email address, or in any other fashion. Any required data that is not accessible in an automatic fashion will be filled in by the tradesman, manually. The tradesman preferably will select a password for use in the system and will review the terms of service, as known.

In addition, the tradesman will be prompted to enter his or her bank account details. Money paid by customers via credit card for services ordered through the system will be transferred to this account periodically, for example, once per month.

The customer's and tradesman's details are stored in a database in a server of the system. Preferably, the tradesmen's details are stored according to category of profession or services provided.

If desired, after registration, the new customer or tradesman can be directed to a How It Works page, which explains the overall operation of the system of the invention. A general overview of the method of the invention, which can be illustrated for the new subscriber, is as follows: the customer selects the required service or repair from the price list of available services, the customer selects the time he or she would like the tradesman to perform the service and enters the address, and the customer places the order. Optionally, the customer uploads and posts a picture of the needed repair, before or after placing the order. The system receives the order and prepares the auction for bidding. The name of the customer, a description of the required service or work (the project) and preferably a photo of the project, and an indication of the general geographical area where the service or work is to be performed is provided to at least some of the tradesmen who indicate they have the required skill set. Preferably, the tradesmen who are included in the auction are selected according to their geographic location and possibly demographics of the local population, according to pre-defined rules. For example, in a city with many tradesmen, the geographical area in which the auction is broadcast can be relatively small, for example, within 8 kilometers, while in a rural area with few tradesmen, the auction can be broadcast over a much larger geographical area.

Now, various tradesmen will submit bids via the app, which can be displayed on the customer's device and on the devices of the other tradesmen in the auction. As in a conventional Dutch auction, tradesmen can reduce their bids a number of times, in response to the bids submitted by their competitors. When the time of the auction is over, the customer has a fixed time, illustrated in FIG. 1 as block 20, in which to select one of the bids and confirm the service or work order for that tradesman. Preferably, the customer has the option of amending or changing the job or replacing it with another job, if it turns out that the original job was not described correctly or that additional services are required from the selected tradesman. As explained below, this will change the price to be paid to the tradesman for that project. The customer selects whether to pay in cash or by credit card for this particular project and pays for the service or work done. And, after the service or work has been done and the tradesman has been paid, the customer is asked to rate the tradesman and, possibly, vice versa.

While the invention is described herein with regard to apps on mobile communication devices, alternatively, the method can be implemented through a website accessible by any suitable computer and/or processing device having two-way communication means. In such a case, registration, bidding and payment are all accomplished on or through the website.

With further reference to FIG. 1, when a customer has a job for which he or she is seeking a tradesman, she will login to the system in order to enter a request. When logging in to the application, a customer's page will appear providing a menu of the options available to the customer. An exemplary customer's page includes the customer's name, preferably with a picture, and links to Add a New Project, My Projects, My Reviews, Settings, Price List and How it Works. Preferably links are also provided to FAQ, Terms of Use, Contact Us, Rate Us, Recommend Us, Log Out, and social media icons, such as Linkedln®, Facebook® and/or Twitter®. The My Projects link leads to a page displaying all previously ordered jobs, indicating the job to be done, the tradesman employed, the date, cost, and the customer's rating or review of the tradesman. The My Reviews link leads to a page displaying all previous reviews of tradesmen by that customer. The Settings link, among other conventional settings, permits the customer to enter payment settings, where the customer may input his or her credit card details for billing purposes. Details of more than one card can be input by each customer, if desired. Preferably, language settings will also be provided to permit display of the various pages in different languages.

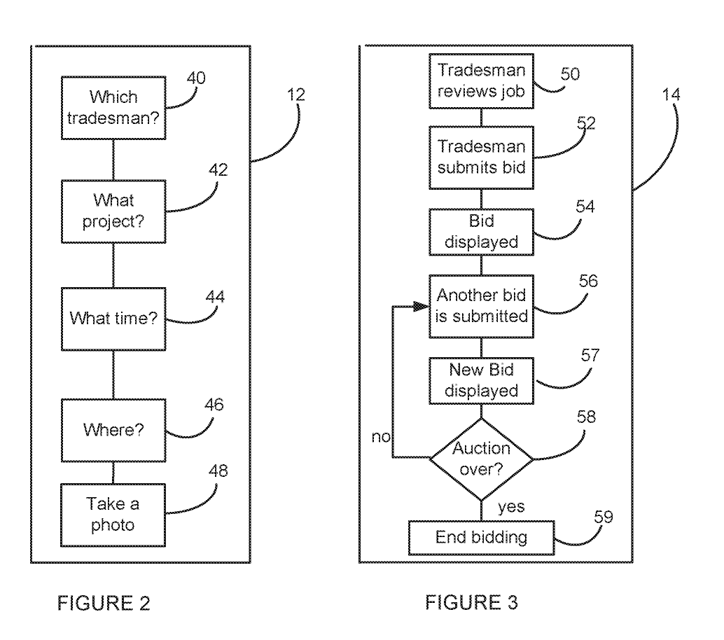

Clicking on the link to Add a New Project takes the customer to an order home page to order a new project (block 12). The order home page can utilize a hamburger menu for options and includes a question mark icon, which can display quick help information related to each page. The service company logo preferably is displayed. The home page directs the customer to answer four simple queries, as shown in FIG. 2:
1. What do you need? (i.e., which tradesman the customer needs) (block 40);
2. For (i.e., what job needs to be done and preferably photos of the area and/or the part which needs repair) (block 42);
3. When (the day and time the customer is available) (block 44);
4. Where (the address of the location where the service is to be provided) (block 46).

Each query preferably opens a new page for selecting the precise response. Alternatively, drop down Combo Boxes can be provided for each query. Thus, when the customer is asked, what do you need? (block 40), he or she can start from the list of categories of all the tradesmen available through the service. Say, for example, the customer has selected a plumber. This selection will cause a page to open listing various jobs or repairs that can be performed that are related to the chosen category (block 42), for example, fix a leak, replace a tap, unblock a drain. If the customer selects “replace a tap”, a new page will open listing the available options under that category, i.e., the different types of tap that can be replaced, together with the list price for each repair. Preferably, photos of the various types of taps is shown.

Once the precise job has been selected, a choose time screen is displayed to the customer (block 44). According to preferred embodiments of the invention, a pre-defined minimum time is required between the time of placing an order and the earliest time for performance. Thus, for example, a customer can order a job for any time starting from two hours after the order and onwards. For example, if it is 12:00 noon at the time of the order, the customer can request that the tradesman arrive at 14:00 or later—the system will not give any other option. This provides sufficient time for bids to be prepared and received, for the customer to accept one of the bids, and for the tradesman to reach the customer. The customer inputs the time request in any suitable fashion. One possible implementation includes “time choice strips” that can be selected by the customer. Each time choice strip will show a time no less than two hours from the current time and showing pre-defined time intervals, preferably quarter hourly intervals, for example, 12:00 12:15 12:30 12:45 13:00, although hourly or any other intervals can be selected.

Once a time has been entered, an address choice screen is displayed to the customer (block 46). The address choice screen can include a keyboard for manual input of an address or can utilize the GPS feature, if any, on the customer's communication device to indicate the location on a GPS driven map.

The complete order is now displayed to the customer and the customer is prompted to take a photo of the service or work that needs to be done (block 48). While not required, a photo often helps the tradesman to understand what, precisely, is required so as to calculate a more accurate cost and give an appropriate bid. Thus, a Take Photo icon can be provided to permit the customer to take and upload a picture of the task that must be performed.

After all four queries are answered, a “Go” button will be displayed. The customer orders the project by clicking on the “Go” link. Now the customer waits to receive bids. At this stage, the customer's device displays a description of the job to be done, the list price, the time the job is scheduled for and the time remaining before the end of the auction. In addition, an option to cancel the job or to add a photo, if not previously added, preferably are provided.

Once the customer has entered the project for auction, the bidding begins (block 14 in FIG. 1). A bid or auction status page opens on the communication devices of all tradesmen in the pre-defined geographical range for that project (block 50; See FIG. 3). This new projects page lists all projects open for bidding for which the tradesman has not yet placed a bid. As soon as a customer posts a project, a new strip with the details of that project will appear on the tradesman's communication device. Each strip on the auction page includes the project title and a short description, preferably including photos. A suggested price for the chosen repair taken from a pre-defined price list, described below, is displayed next to the project.

If the tradesman is interested in a project, he can see further details by clicking on the project strip. A new page will display details of the customer: name, address of the job, preferably with a map icon, possibly a customer photo, and the job details: time and date, type of tradesman sought, brief description of the service or work to be done, preferably a photo of the project, and the price list cost, as well as the current lowest bid. A Timer may be provided to indicate the time left for this auction.

Each tradesman who is interested in this project can submit a bid by clicking Bid Now and entering a bid (i.e., a price for performing the job at the desired time and location) (block 52). The bid will be displayed (block 54) on a project progress screen of each of the tradesmen in the auction and on the customer's screen. If desired, the system can provide a pop-up message to the customer and/or the tradesmen each time a new bid is entered. Each bid can be presented on a strip including the tradesman's name and his bid price. Preferably, the tradesman's rating is indicated together with the number of jobs he or she has completed and a link to reviews of the tradesman. A Timer is provided to indicate the time left for this auction.

Typically, another tradesman will submit a bid (block 56), which will also be displayed (block 57) to all the tradesmen and the customer. As in conventional auctions, each tradesman can submit multiple bids in response to the progress of the bidding until the auction is over (block 58), at which time the bidding ends (block 59). The tradesman's display will also include a link to add a new bid, if the tradesman wants to change his bid, for example, to one the same as or lower than the lowest current bid. According to embodiments of the invention, the system provides a pop-up alert when another tradesman gives a lower bid and suggests changing to a lower bid.

Each tradesman can see all his or her pending bids on an Active Bids page. The projects listed in Active Bids can be divided into two groups, as by color or other graphic indication. The first group includes those projects for which the bidding is still continuing. According to some embodiments, the current lowest bid is also displayed on the order strip. This permits other tradesmen to see the bidding and decide whether and how much to bid themselves and provides the option of posting an updated bid, if desired. The second group includes those projects for which the bidding has ended but the customer has not yet decided which tradesman to hire to do the job.

According to embodiments of the invention, the tradesman also has a projects page, for example, including three tabs. The first tab, Bidding in Progress, includes those projects for which the auction is still open and bidding is still continuing. The second tab, Projects in Action, includes those projects for which the tradesman has been hired and which are waiting for completion. The third tab, Completed Projects, is a record of projects that have been accepted and completed and preferably a description of the completed projects and/or photos are uploaded by the tradesman at the project site before and/or during performance of the service and after completion of the project.

When the auction ends (block 16 in FIG. 1), the customer has a pre-defined amount of time, for example, 20 minutes, within which to consider the various bids (block 18) and choose a tradesman to perform the job (i.e., accept a bid)(block 22). Optionally, while the decision time is running (block 20), this can be indicated to the tradesman on the active bids page, for example, by means of a transparent hover with the words “waiting for approval” over the project strip or other indication. Preferably, the system will provide one or more reminder notifications to the customer indicating the time remaining for making the decision. If the customer does not choose a tradesman within the pre-defined time, the job will be canceled (block 26). Alternatively, or in addition, the “auction end” timer can be replaced with a “time left for approval” timer that will show a countdown clock of the pre-selected time during which the customer must choose a tradesman to perform the job.

According to embodiments of the invention, when the auction ends, the lowest bidder is presented by default to the customer for approval. The price bid for the project and the time the tradesman is expected to arrive are also displayed. A link is provided with the winning tradesman's details. Activating this link will cause a tradesman profile page to pop up, with his or her image, phone, address, brief description, Facebook® link if there is, website, rating, read reviews button, completed jobs and any other information selected by the service. In addition, a Reviews popup can be provided. If clicked, the popup will open with rectangles, the review text and a rating indicator, as described in detail below. In this way, the customer can learn about the tradesman before deciding whether to accept or reject the bid. Should the customer prefer to review other offers before accepting the bid, he or she can select the link to Choose Another Tradesman and all the bids, with details of the tradesmen and access to their reviews, will be presented to the customer for selection. A reminder of the remaining time may also be displayed. If the customer does not accept any of the bids during the decision time, the project order is canceled (block 26)

Once the bid by a selected tradesman has been accepted, the tradesmen who were not hired are informed that they did not win that bid.

It will be appreciated that the exact location of the job to be performed is not required during the auction phase, only a general geographical area so the tradesman can calculate time of arrival and ease of access before bidding. The precise address and phone number of the customer preferably are provided only to the tradesman who wins the auction and is to perform the job.

When the customer accepts one of the bids (block 22), a successful bid acceptance notification appears on the display of the customer and on the display of the tradesman. Similarly, a notification that a bid was not accepted will be sent to the bidding tradesmen who were not accepted. The tradesman whose bid was accepted will see on his display complete details of the project, preferably including a photo of the project, a picture of the customer, his telephone number, his address with a map icon near it, and a review button. If desired, the map can be configured to show the customer's location as well as the address of the project. The display also includes the time scheduled for the job to be done. Pressing the review button will show the customer's profile to the tradesman, as described below.

Similarly, a customer acceptance screen can be displayed. This screen shows the picture of the tradesman, his telephone number, the address where the service or work is to be performed with a map icon near it, and a review button. If desired, the map can be configured to show the tradesman's location in real time as he moves towards the customer. The display also includes the time scheduled for the job to be done. Pressing the review button will show the tradesman's profile to the customer, as described below.

At the given time, an indication that the selected tradesman has arrived at the location of the repair (block 24) is provided to the server. If the tradesman does not arrive within the designated time window, the project can be canceled (block 26). Either the tradesman and/or the customer should indicate that the tradesman has arrived, for statistical purposes of the server. If no such indication is received and the tradesman can be seen on a GPS map to have reached the address of the job, an automatic indication that the tradesman has arrived will be generated. If the tradesman did not arrive, this is also noted in the server. Or if the customer was not present to permit the tradesman to do the job, an indication that the job was canceled is also stored in the server and a fee must be paid to the tradesman.

If the customer wishes to add another project or change the ordered project (e.g., replace a different kind of tap or also stop a leak) once the tradesman has arrived, the tradesman can handle the changed project on the spot (block 28). It will be appreciated that, once a different repair is chosen and performed (block 30), the price will change, as the winning auction bid is no longer relevant. Preferably, the price is taken automatically from the suggested retail price list in the system. These changed details are preferably entered by the customer on a customer project completion page.

If the project or repair is canceled after the tradesman has reached the project address, a pop up will be displayed with a message notifying the customer he must pay the tradesman for the visit (a call charge) and a text box for the customer to write the reason for cancelation. This text box preferably is mandatory. Project cancelation reviews, before or after the tradesman arrives, are requested from the customer, to provide an indication under what circumstances projects are canceled.

Once the job has been completed (block 30), the customer will confirm the details of the needed repair, as set forth in the bid, and the selected tradesman who accepted the project. Preferably, this page contains an Edit icon or other option to edit the project details, to indicate the repairs actually performed. This can include a dropdown with the chosen repair that, once clicked, will let the customer choose another repair (if the costumer was mistaken and chose the wrong repair). In addition, an add repair button can be provided to add another repair. This button can also be a dropdown table that will show fixed prices for repairs from all categories, such as on the home page. Preferably, below this list, an option to write the customer's own repair will be provided, which will open a small text box.

The customer now activates a Pay and Review link to move to the payment page (block 32). Pressing the pay and review button causes a screen to open prompting the customer to indicate whether he or she will pay in cash or by credit card. If cash, the customer pays the agreed amount to the tradesman before proceeding to the review screen. If credit card, the customer will then be prompted to enter his or her credit card details for the payment, which can be processed in any conventional manner, and payment must be confirmed.

After completion of the job, a project completion and review screen will open for the tradesman to confirm the details of the project and the bid. If desired, the tradesman can be prompted to indicate and store the time required for performance of the job, the details of the job including a description of the service or work, including the operations performed, parts repaired or replaced, and optionally photos of the service or work before, during and after completion, for later viewing (not shown). This data is also entered for processing and storage in the server. Preferably, this page, also, contains an option to edit the project details, to indicate the repairs actually performed, and an opportunity to indicate that the job was canceled, if it was.

After the job is completed and paid for (block 34), both the customer and the tradesman provide feedback about each other. These details are useful to provide reviews and ratings of both customers and tradesmen, to ensure that they should be retained in the service. In addition, customers and tradesmen have access to the reviews of one another and to details of prior jobs and projects relating to either one of them, while making the decision whether to bid on a project or to accept a certain tradesman. Accordingly, star ratings preferably are required, while written reviews are optional. While an overall star rating can be requested, preferably the customer and tradesman are prompted to provide individual ratings for different aspects of behavior on the job, for example, arriving on time, courtesy, quality of service or work, cleanliness, etc.

The customer review screen may include the name of the tradesman, the project title (e.g., repairs performed), the project price and a rating scale for desired characteristics, for example, arriving on time, the customer's satisfaction with the price and with the quality of the service or work. Preferably, a box for a free text review is also provided. If desired, a box to add a tip can optionally be provided. When completed, the review is submitted by pressing the rate and complete button. In case the tradesman did not arrive, this can also be indicated in the customer review screen.

Similarly, the tradesman can fill in a tradesman review screen. This screen includes the name of the customer, the project title (e.g., repairs performed), the project price and a rating scale for desired characteristics, such as being at the location on time, whether payment was made on time, and the tradesman's satisfaction with the customer's behavior. Preferably, a box indicating that the customer was not home is also provided. When completed, the review is submitted by pressing the rate and complete button.

At most stages of the auction process, a reviews button or popup can be provided. If clicked, the popup will open to display various review texts and a star rating indicator. This displayed star rating can be an overall rating, while individual ratings are provided for each job, for example, arriving on time, courtesy, quality of service or work, etc. An exemplary tradesman review screen can include several categories of skill sets of that tradesman. Each trade or skill set will have its own review page, provided by customers when the tradesman accepted projects in the various categories. Preferably, tabs (not shown) can be provided to navigate between positive feedback and negative feedback. In order to read more feedback, the customer can scroll down inside the popup. It will be appreciated that, since all the project details and review pages are stored in the server, it is possible to present a project history of a particular tradesman or customer.

All this data is available for viewing by the tradesman and the customer. As mentioned above, a tradesman finished project screen can be provided, including the name and photograph of the tradesman, together with his skill areas and an overall star rating for all completed jobs. This header can appear above details of each job. The particular job details are then displayed. These can include the time the project was scheduled, the time the tradesman and customer arrived, the time the service or work was completed, a description of the service or work actually provided optionally accompanied by photos, the amount paid and the method of payment, the customer's star rating for that project and a written review, if any. If desired, other bids that were not accepted can also be presented.

According to embodiments of the invention, an unregistered guest can request services. However, he or she will be required to enroll in the system before the details of the job will be broadcast to the relevant tradesmen for bidding.

As described above, the server typically includes a database including a Recommended Price List for the various repairs in each category. These prices are defined as the highest prices to be paid or requested for each particular project. One suitable price list is that compiled by Itzhak Levy in Israel or another price list approved by a Bureau of Commerce or other suitable authority. According to alternative embodiments of the invention, if the customer doesn't know what kind of repair is required, the customer can merely take a photograph of the required repair, without using a price list. The photo will be broadcast, rather than a description in words, and each tradesman can submit any bid he or she deems appropriate.

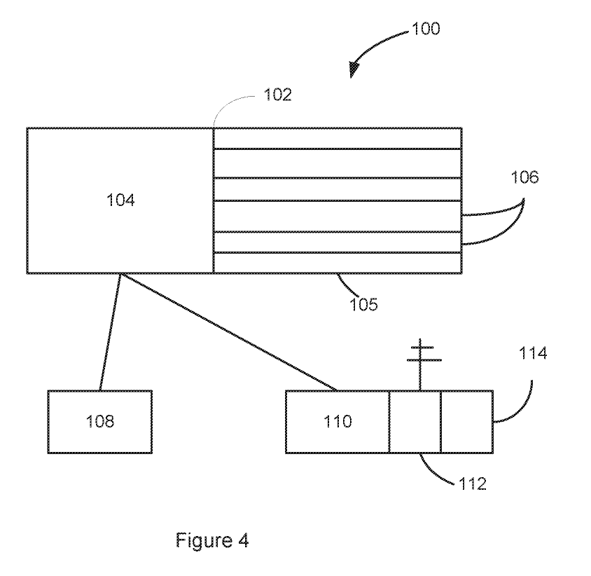

One exemplary system 100 suitable for implementing the present invention is illustrated schematically in FIG. 4. The system 100 for providing and/or obtaining tradesman services includes a server 102 having a processor 104 and holding a database 105 of tradesmen, organized according to profession or category 106. The processor in the server is coupled to a plurality of tradesman communication devices 108 (only one of which is shown for ease of illustration), having a display and may be coupled to a camera (it can be and internal or external camera), and a plurality of customer communication devices 110 (only one of which is shown for ease of illustration) having a display. Preferably, each customer communication device 110 includes a device for determining geographical location, such as a GPS receiver 112 and is coupled to a camera 114 (which can be internal or external) and. The server includes means for providing two way communication between the server and the tradesman communication devices 108 and between the server and the customer communication devices 110 (not shown). The processor is adapted and configured to receive a request to perform work or service by a tradesman in a selected category and publish the request among the tradesmen in the selected category in the database. An auction is conducted via two way communication between the tradesman communication devices and the customer communication devices via the server to perform the requested service or work. The tradesman communication devices and the customer communication devices include a geographical location mechanism, such as a GPS driven map, which uses coordinate data of the real world locations to show the customer where the tradesman is and show the tradesman where the customer is, as well as indicating the physical location of the project. The system further includes a payment mechanism for collecting payment by the customer and transferring it to the tradesman.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A method for obtaining tradesman services, the method comprising:
creating a database of tradesmen according to skill category;
receiving a request to perform a service by a tradesman in a selected skill category at a selected time and at a geographical location;
broadcasting the request among at least a portion of the tradesmen in the selected category in the database;
conducting an auction to perform the requested service among the tradesmen to whom the request was broadcast, including receiving at least one bid from at least one of said tradesman;
displaying said at least one bid on communication devices of a customer requesting the service and other tradesman in the auction;
receiving a customer selection of one of said at least one displayed bid; and
notifying the tradesman who made the selected bid.

2. The method according to claim 1, wherein said step of selecting includes selecting the tradesman who provided the lowest bid.

3. The method according to claim 1 or claim 2, further comprising:
receiving an indication that the tradesman has performed the requested service; and
storing a customer rating of the tradesman and of the requested service for later viewing.

4. The method according to claim 1, further comprising:
storing a description of the service including a description of the operations performed and parts repaired or replaced, for later viewing.

5. The method according to claim 4, wherein said step of storing includes storing photos of the project before, during and after completion of the service, for later viewing.

6. The method according to claim 1, wherein said step of broadcasting includes broadcasting a photograph, uploaded by the customer, of the requested service.

7. The method according to claim 1, wherein said step of broadcasting includes broadcasting within a pre-defined geographic area relative to geographical location of the requested service.

8. The method according to claim 1, further comprising creating a database of subscribing customers including at least name, address and phone number of each subscribing customer.

9. A system for providing and/or obtaining tradesman services, the system comprising:
a server holding a database of tradesmen arranged according to skill category;
a processor in the server coupled for two-way communication to a plurality of tradesman communication devices, each said tradesman communication device having a display, a geographical location identifier, and to a plurality of customer communication devices, each said customer communication device having a display, and a geographical location identifier;
the processor coupled to said customer communication devices for receiving from one of said customer communication devices a request to perform a service by a tradesman in a selected skill category at a selected time and at a geographical location;
the processor coupled to said tradesman communication devices for broadcasting the request among the tradesman communication devices of at least a portion of the tradesmen in the selected skill category in the database; and
the processor adapted and configured to conduct an auction among the tradesmen to whom the request was broadcast to perform the requested service, including receiving a signal from at least one of said tradesman communication devices indicating a price bid and causing a graphical representation of the bid to be displayed on a display of the customer communication device and the tradesman communication devices that received the broadcast; and
a graphic confirmation of performance of the requested service and payment therefor.

10. The system according to claim 9, wherein said tradesman communication devices are being coupled to a camera;

11. The system according to claim 9, wherein said customer communication devices are being coupled to a camera;

12. The system according to claim 11, further comprising a photograph of the service to be performed provided by said customer.

13. The system according to claims 10, further comprising a photograph of the service performed provided by said tradesman.

14. The method according to claim 2, further comprising:
receiving an indication that the tradesman has performed the requested service; and
storing a customer rating of the tradesman and of the requested service for later viewing.

15. The system according to claim 9, further comprising a photograph of the service to be performed provided by said customer; and,
a photograph of the service performed provided by said tradesman.
